(19) United States
(12) Patent Application Publication
(10) Pub. No.: US 2010/0036615 A1
(43) Pub. Date: Feb. 11, 2010

(54) Method for Measuring Information of Technical and Biological Systems

(75) Inventor: Ralf Otte, Weinheim (DE)

Correspondence Address: SHOEMAKER AND MATTARE, LTD, 10 POST OFFICE ROAD - SUITE 100, SILVER SPRING, MD, 20910, US

(73) Assignee: TECDATA AG, Uzwil (CH)

(21) Appl. No.: 12/527,378

(22) PCT Filed: Feb. 14, 2008
(86) PCT No.: PCT/CH08/00062

§ 371 Date: Aug. 14, 2009

(30) Foreign Application Priority Data
Feb. 15, 2007 (DE) 102007008021.4

(51) Int. Cl. G06F 19/00; G06F 15/00

(52) U.S. Cl. 702/19; 702/190; 702/127

(57) ABSTRACT

The invention relates to a method for measuring potential information of a biological or technical system. The aim of the invention is to receive signals using less energy. To achieve this, random generators are used as receivers of low-energy quanta, since the random generators can be regarded and implemented as antennae and receivers of signals of this type. The extensive natural transmission range of low-energy quanta can also be used to receive potential information from systems.

The invention relates to a method for measuring information from technical and biological systems.

The method is suitable for measuring the current potential entropy state and information state of a technical installation or a biological system.

It is generally known for information to be measured, to be transmitted, to be received and to be evaluated by suitable methods.¹ ¹Fritsche, Witzschel: Informationsübertragung [Information transmission], VEB Verlag Technik, Berlin, 1989

One disadvantage of the conventional methods is that a relatively large amount of energy must be consumed in order to transmit information. Even the most modern types of mobile telephones, for example, consume several watts or milliwatts of transmission power in order to transmit speech information.

In order to transmit the information (messages) by means of electromagnetic waves, the messages are modulated onto a carrier wave at a suitable frequency and with a suitable power (for example amplitude or frequency modulation), and are sent, and this modulated carrier wave can then be received, decoded and processed further by a receiver. In this case, antennas of suitable length (λ/2 or λ/4 dipoles) or other resonators with a suitable characteristic impedance or radiation impedance may be used as receivers for electromagnetic waves. It is prior art to receive or to transmit waves at a frequency of, for example, 30 kHz to 30 THz, corresponding to wavelengths from 10 km to 10 μm. Waves at higher frequencies, for example infrared or optical frequencies, are also technically processed and, furthermore, in a number of physical specific disciplines (for example nuclear physics), electromagnetic waves are used at an extremely high frequency and with extremely high energy, for example gamma rays.

However, it is problematic or in some cases impossible to receive, to process and to send very long electromagnetic waves, that is to say waves whose frequency is in the extremely low range, for example in the Hertz range, and which therefore have wavelengths of several hundred or thousand kilometers. This is therefore technically difficult because resonators (tuned circuits) with an extremely low resonant frequency and nevertheless a suitable characteristic impedance are required for reception, and this necessitates antenna installations with a very large spatial extent. Technical approaches exist for use of the Earth's ionosphere itself as an antenna, and therefore for producing or manipulating waves with a very long wavelength, although this requires a very high degree of hardware complexity and is therefore feasible for only a small number of facilities. However, even these approaches fail when one wishes to receive electromagnetic waves with wavelengths of several tens of thousands of kilometers.

It is also known that the waves have both a particle and a wave characteristic, and that the associated characteristics can be determined using different measurement methods. It is state of the art that electromagnetic waves comprise quanta which obey the laws of quantum physics. One example is the known double-slot experiment, which indicates the wave character of such photons or quanta, and other experiments which, for example, measure the radiation pressure, indicate the particle character of such quanta.² ²D. I. Blochinzew: Grundlagen der Quantenmechanik [Principles of quantum mechanics], Verlag Harri Deutsch, Frankfurt, 1988

Since there is a unique mathematical relationship between frequency and energy, it is impossible according to the present prior art to receive and to deliberately transmit quanta, for example electromagnetic quanta, with extremely low energy (at an extremely low frequency).

The invention is based on the object of specifying a method and a device by means of which quanta, so-called low-energy or very low-energy quanta, that is to say for example quanta with energies of less than 10⁻³² Joules—can be measured, received and evaluated in order in this way to provide novel application possibilities.

This object is achieved by a method specified in claim 1 for measuring potential information from technical or biological systems, in which the low-energy signals are received and evaluated by suitable receivers, so-called random number generators, with the physical relationship between frequency and energy according to E=h*f being used (where E is the energy of one quantum, f is its frequency and h=6.626*10⁻³⁴ Js, the so-called Planck's constant³), in order to determine the energy of the signal to be received, and to design the random-number generators as receivers or transmitters of such low-energy signals. ³Brandt, Dahmen: Quantenmechanik auf dem Personalcomputer [Quantum mechanics on a personal computer], Springer-Verlag, Berlin, 1993

Advantageous refinements are disclosed in the dependent claims.

The new approach for measurement of very low energies and therefore very low frequencies results in technical application options which have hitherto been unknown.

In order to assist understanding of the invention, an information conservation rule of nature is postulated in parallel with the energy conservation rule, which states that information can never be lost. Like energy as well, information can only be converted from one form (for example random information—entropy) to a different form (structure information), i.e.

total information I=structure information S+random information H+remaining information U

I=S+H+U (1.1)

U represents an unknown type of information which may also need to be introduced. At the instant at which a random information item H is converted to structure information S by semantic knowledge, nothing has changed in the overall information I of an object, in accordance with equation (1.1).

The abovementioned parallels between energy conservation and information conservation mean that an entropy exchange (information exchange) must take place between two objects of different entropy density (information density), in the same way that an energy exchange takes place between two objects of different energy, until the energy difference is equalized.

If there is an entropy difference ΔH=H₁−H₂ between two objects 1 and 2 and there is a capability, of whatever type, to equalize this, then the entropy flow H_{F} is:

H_{F}˜ΔH (1.2)

The entropy flow H_{F} is in this case proportional to the entropy gradient of the two objects, and its direction is such that the entropy flows from the object of high entropy (for example H₁) to the object of low entropy (for example H₂) until the entropy has been equalized.

As a result of the relationship (1.1) between entropy H and information I, the entropy transfer can be equated to an information transfer, that is to say information transfer and entropy transfer are regarded as equivalent in the description, since they can mathematically be converted to one another. For example, the total information in a bit sequence of 20 bits is 20 bits. How many bits thereof are structure information and how many are random information in this case depends on the context, but the two can be converted to one another. However, for simplicity, the following text refers to entropy transfer.

It is known that information is exchanged between two objects by means of so-called quanta (for example quanta of the electromagnetic field, that is to say photons) of a specific energy and at a specific frequency. In this case, it is in general normal for quanta with a specific energy, which are emitted as an electromagnetic wave at the wavelength k to be received by specific apparatuses and methods. Tuned circuits such as those in any radio receiver are normally used for this purpose. The tuned circuit must in this case be tuned to the frequency f of the wave (where f=λ/c and c is the speed of light), and an antenna is required for reception. It is known that, inter alia, the antenna must obey the λ/4 law, that is to say the length of the antenna dipole should be λ, λ/2 or λ/4.⁴ ⁴Liebscher: Rundfunk-, Fernseh-, Tonspeichertechnik [Broadcast radio, television, audio storage technology], VEB Verlag Technik, Berlin, 1981

It is also known that these methods and devices can receive only waves up to a specific wavelength, for example long waves. Waves whose wavelength is even longer (for example 10 000 km or more) and which are therefore at an extremely lower frequency with a low energy level, cannot be received according to the present prior art.

By way of example, conventional television waves are at a frequency of more than 30 MHz, that is to say wavelengths of less than 10 meters. Conventional LW radio waves are at a frequency of >30 kHz, that is to say wavelengths of less than 10 kilometers. The electromagnetic radio waves and frequencies of conventional technical applications normally vary within this range. However, there are numerous technical applications using much higher frequencies, for example microwaves (λ=1 mm to 1 m, f=300 MHz to 300 GHz), spectroscopes (λ=30 μm to 3 mm, f=0.1 THz to 10 THz) or infrared remote controls (λ=780 nm to 1 mm, f>300 GHz). Very long waves, such as those which are received and/or transmitted by specific installations are, for example, at a frequency of 3 kHz and their wavelength is therefore <100 km. The reception of waves (quanta) at a wavelength of several hundred or thousand kilometers is at present technically impossible, or is possible only with an extremely high degree of complexity.

The object of the invention is to develop a method for measuring information, which allows waves at extremely long wavelengths (up to several thousand kilometers and more) and therefore with extremely low energy, to be received.

According to the generally known equations λ=c/f and E=h*f, and using h≠6.63*10⁻³⁴ J, the wavelength following 8 Hz, for example, and therefore the energy of the 8 Hz quanta that follow this correspond to: λ=37 500 km and E=5.3*10⁻³³ J.

From the Heisenberg uncertainty theorem⁵

Δp*Δx≧h (2.1.)

where Δp is the accuracy of the impulse, Δx is the accuracy of the location, and h is Planck's constant, it is evident that these abovementioned 8 Hz quanta are undefined over the location of 37 500 km. ⁵ W. Heisenberg: “Über den anschaulichen Inhalt der quantentheoretischen Kinematik und Mechanik” [On the evident content of quantum-theoretical kinematics and mechanics] 1927, in “Dokumente der Naturwissenschaft” [Documents of Natural Science], Physics, Battenberg Verlag, Stuttgart, 1963

The following terms are introduced for the rest of the description (the subdivision is simplified and serves only to clarify the terminology, the physically exact limits can be found in the literature):

| | | Wavelength | Energy | | |
|---|---|---|---|---|---|
| | Frequency | examples | examples | Name | Abbreviation |
| 1 | >10²⁰ Hz | <3 pm | 6.63 * 10⁻¹⁴ J | Gamma quanta | GQ |
| 2 | 10¹⁴ Hz | 400-700 nm | 2.8 * 10⁻¹⁹ J-4.9 * 10⁻²⁴ J | Photon | — |
| | | | | quanta/photons | |
| 3 | 100 kHz-5 GHz | 6 cm-3 km | 6.63 * 10⁻²⁹ J-3.31 * 10⁻²⁴ J | Radio quanta | RQ |
| 4 | 1 Hz-100 Hz | 3000 km-300 000 km | 6.63 * 10⁻³⁴ J-6.63 * 10⁻³² J | Low-energy quanta | LEQ |
| 5 | <1 Hz | >300 000 km | 6.63 * 10⁻³⁴ J | Very low-energy | LSTEQ |
| | <<1 Hz | | (e.g. also 10⁻¹⁰⁰ J) | quanta = entropy | |
| | | | | quanta | |

The invention makes it possible to receive LEQ quanta or LSTEQ quanta, with it also being possible to receive other quanta (for example radio quanta). Nowadays, suitable technical solutions (radio, television and mobile-telephone receivers) exist for receiving radio quanta, but no receivers yet exist for receiving low-energy quanta, for which reason the description concentrates on the latter. The technical embodiment for receiving both low-energy quanta (4, 5) is the same, with the only difference being the application options. For example, LEQ quanta are suitable for remote monitoring or diagnosis, and LSTEQ quanta are predestined for prediction tasks. The terms low-energy quanta and very low-energy quanta are, however, always used synonymously in the following text where no distinction is necessary.

There are a number of possible ways to carry out the invention, two of which will be mentioned by way of example, with the variant 2.1.b) being described in more detail:

2.1.a) Reception of the signals by receivers whose conductor tracks have been appropriately physically designed and manufactured. By way of example, even in 1985, the conductor track lengths on integrated circuits were around 40 km long. If it is assumed that these conductor tracks correspond to technical antennas, it was therefore possible to receive frequencies of 7.494 kHz.
According to the invention, appropriate receivers which have a specific conductor track configuration are constructed for receiving signals with very low energy. This embodiment is admittedly technically demanding, but is physically and conceptually trivial.
One interesting side-effect is that, even today, all technical devices with conductor track runs such as these, for example computer processes, deliberately or inadvertently receive and transmit such signals with very low energy, and these cannot be screened without a clearing system (see below). Communication therefore takes place deliberately or inadvertently all the time between, for example, processors and other processors or biological systems.

2.1.b) Reception of signals by measuring the influence of microsystems, such as atoms, electrons, etc. Beyond a certain very low energy level, the complexity of the design and construction of antennas according to engineers is no longer possible or is too expensive, which means that a fundamentally different method must be used. According to the invention, systems are used for this purpose, for example, which have a certain arrangement of microparticles, whose change can be recorded. By way of example, boundary surfaces of semiconductors, radioactive decomposition processes, designs in which photons are reflected with a certain probability, and many more, are suitable for this purpose.

A novel measurement method, based on 2.1.b), for measuring quanta with very low energies is represented by the use of noise generators, such as those which are conventionally used for generating random numbers.

According to the invention, a random process is therefore used for receiving signals (quanta). The random process must be suitably designed for receiving signals of very low energy (LEQ, LSTEQ quanta).

Suitable random processes can be implemented by mathematical random number generators (pseudorandom number generators, time decomposition generators, π random number generators) or physical random number generators (physical noise generators). The noise signals of physical noise generators may in this case be created by a very wide range of physical processes, for example by thermal noise, radioactive noise, magnetic noise, otoacoustic noise, biological noise, photon noise etc. In these processes, the movement of microparticles (for example electrons at semiconductor boundary surfaces in the case of thermal noise) or photon quanta in the case of photon noise (Quantis devices⁶) are converted to an electrically measurable signal, which is then interpreted as a noise signal (random signal). ⁶www.idquantique.com

According to the invention, signals from random processes are often not actual random signals but they indicate the reception of very low-energy waves whose energy is just sufficient, for example, to influence the microparticles (electrons) of a noise generator.

One known technical example for the reception of broadband signals is provided by so-called fractal antennas which are used nowadays in numerous applications (for example mobile telephones, cars), since it is possible, by miniaturization, to produce extremely small antennas which can nevertheless receive the desired wavelengths (Fractal Antennas: A Novel Antenna Miniaturization Technique and Applications, J. Gianvittorio and Y. Rahmat-Samii in IE-EE Antennas and Propagation Magazine Vol. 44, No. 1, February 2002).

Antennas such as these are also formed on the boundary layers of the pn junctions of semiconductors. The doping process creates molecule structures which are similar to technically produced fractal antennas, although on a different scale. The naturally formed fractal antennas of semiconductor components are suitable for reception of broadband signals. Since their structures—although folded—are physically large, they are suitable for receiving low-frequency signals. This means that even simple diodes can be used to receive LEQ and LSTEQ quanta.

Avalanche diodes are particularly suitable for receiving biological signals and zener diodes are suitable for receiving technical signals. Alternatively, the conductor tracks of complex digital switching networks, such as processors, are also technically suitable for receiving the abovementioned LEQ and LSTEQ quanta.

The microparticles and their natural or technical use for tuned circuits are therefore, according to the invention, antennas for LEQ and LSTEQ quanta. Their three-dimensional arrangement on a boundary surface governs the capability to receive signals at a specific wavelength, since the antennas and the wavelength of the signal must satisfy a specific resonance condition. The length of an antenna such as this on semiconductor boundary surfaces may be several meters to thousands of kilometers, thus allowing reception of signals at a corresponding wavelength.

It is generally known that the semiconductor effect is a quantum-mechanical effect since, as a result of entanglement of electrons (holes), entire columns of electrons (holes) act like a single electron (hole), and can migrate through the semiconductor. Thus, in the end, reception by means of semiconductor noise generators is based on a quantum-mechanical process (Robert B. Laughlin, Abschied von der Weltformel [Departure from the world formula], Piper Verlag, Munich, 2007). This is advantageous since this makes it possible to deliberately make use of quantum-mechanical effects.

Every semiconductor is thus an information receiver based on a quantum-mechanical process, which obeys the laws of emergence. Specific patterns of emergence are created in spatial and/or time proximity.

The physical effects of self interference of quanta as described in this invention are made technically useful by the use according to the invention in particular of semiconductors as antennas for very long waves, that is to say low-energy quanta (LEQ, LSTEQ). Semiconductor-based noise generators are therefore information receivers which, based on physics, allow quantum effects of the low-energy range in applications which can be used technically. From the technical point of view, it is therefore irrelevant whether the quanta are received by fractal antennas on the boundary surfaces of the semiconductors (and therefore satisfy the known λ/4 conditions, page 5) or whether their reception is made possible by time self-entanglement of the quanta, and therefore are created directly by time sampling of the random signal.

Random number generators and noise generators are information receivers and entropy receivers. They permanently receive the energy and entropy (information) from the objects surrounding them.

FIG. 1 shows a device DEVICE for receiving quanta. The quanta LEQ from the environment ENV at a distance s from the appliance DEVICE are received by a random number generator RNG and change its noise response. The resultant random number sequences⁷ are passed to a processing unit PRZ, where they are evaluated and compared. ⁷Although the random number sequences of a noise generator are, according to the invention, created by the reception of quanta, that is to say they are causal, they will nevertheless be referred to in the following text as random number sequences because these sequences pass all the statistical tests for randomness. This is because of the fact that the tests carry out a statistical analysis of the sequence and not a semantic analysis. A semantic evaluation has also not been necessary until now since the sequences from noise generators have actually and not just apparently been assumed to be random. Although there is a causal influence of random number generators, their sequences always appear random since the generators represent an additive and/or multiplicative superimposition of a very large number of complex states of received quanta.

As in information technology, the resonance condition between an object which emits quanta and a receiver is normally satisfied precisely when the receiver can receive the frequency (wavelength). However, in contrast to conventional information technology, this always relates to the exchange of very low-energy quanta, that is to say quanta at a very low frequency and a very long wavelength. Other forms of the resonance condition are disclosed on page 17. Particularly when information is being exchanged, a semantic resonance condition must be created, since the receiver would otherwise not identify the information from the transmitter as such at all but would interpret this as a random signal.

One example of random number generators being able to receive low-energy quanta (even LEQ quanta) is well known to those skilled in the art. For example, when designing random number generators (for example thermal noise generators), particular care is taken to ensure that these generators are screened from alternating-current influences. In Europe, the alternating current is at a frequency of 50 Hz, which, according to E=h*f, corresponds to its quanta having an energy of 3.31*10⁻³² J and being at a wavelength of approximately 5995 km. Random number generators can therefore already today receive quanta with an energy of 3.31*10⁻³² J. If the generator is not very well screened or is not designed by means of suitable measures such as the construction of balanced circuits for the alternating-current components in the noise to cancel one another out, then the influence of the alternating current in the trend image of a noise sequence indication system can even be identified with the naked eye. Random number generators that have been influenced in this way therefore do not pass statistical tests for randomness. The “non-voluntary” reception of low-energy quanta (for example 50 Hz quanta) in random number generators therefore nowadays has an extremely disruptive effect although, so far, this has not been identified per se.

One major component of an information exchange of low-energy quanta such as this is that, using methods that are already known, screening can be carried out only with difficulty since 1) the energy of the quanta is so low that the quanta can often interact only to a very minor extent with the surrounding materials (electrons, atoms, nuclei) and can therefore pass through these materials and 2) particularly in the case of low-energy quanta, effects of the electromagnetic near field, in particular the radial component effect (longitudinal component) are used. This means that myriads of quanta are permanently flooding our environment. Every biological and technical system can filter out and further process those quanta which are useful to it from this “quantum mixture”, by suitable filtering, addressing and calibration routines.

It is thus possible to measure the information state of a human being, an animal, an installation or any other technical or biological object and system over a long spatial distance. Low-energy quanta are always exchanged during such a measurement. According to the invention, information can therefore be received about desired objects. The objects may be at a long spatial distance, which may be several thousand kilometers or considerably more. The objects may be human beings, animals, technical installations, appliances of any type, automobiles, power plants, airplanes, computers etc.

If the detectors are used to receive very low frequency signals, then this results in special factors. It is known from information technology that electromagnetic waves have two fundamentally different areas: the near field and the far field (Zinke, Brunswig, Hochfrequenztechnik 1 [Radio-frequency technology 1], Springer Verlag, 6th edition, Berlin, 2000). In the technically conventional case, the characteristics of the far field are used, and these are essentially based on the transversal characteristics of Hertzian waves. This is because the expression “near field” is used only up to a distance of one to two times the wavelength, and beyond this is referred to as a far field. The frequencies which are normally used nowadays therefore have a near field which is small, with a maximum of only a few centimeters or meters. This is not applicable to LEQ frequencies. The waves used here have a wavelength of up to 300 000 km (1 Hz) generally 30 000 km (10 Hz).

For example, if f=50 Hz, near field still exists at a distance of 1000 km (ibid., page 386).

The characteristics of the near field must therefore also always be taken into account for any application of LEQ frequencies on the Earth. It is now also known from information technology that, particularly in the near field, every electromagnetic signal also has longitudinal components (radial components); this longitudinal component in particular contributes to the separation of the Hertzian wave (ibid., page 388). In the near field, magnetic and electrical components of the field are phase-shifted through 90 degrees, but they are not in the far field. Since the longitudinal components fall with 1/r³ (when r is the distance to the transmitter), the transversal components fall only at 1/r², however, only the transversal characteristics of the wave therefore still exist beyond a certain distance from the transmitter, and this is made useful by the normal technical applications nowadays.

However, there are other phenomena in the near field. The longitudinal component can be screened only with difficulty using conventional methods. However, this means that the signal sources which, for example, oscillate in the 10 Hz range, build up a near field, which can be screened only with difficulty, from 10 000 to 30 000 km around themselves.

Low-energy quanta have a high degree of spatial penetration and can be received virtually everywhere on the surface of the Earth.

States of technical and biological objects can therefore be received by suitable receivers everywhere on the Earth. The signal transmission is therefore reduced to the reception and in particular filtering out the desired signals from the signal mixture at the receiver, because every random process, in particular every semiconductor component receives the signals from millions of transmitters, and these are all superimposed. The superimposition produces from this the random signal, which can be identified by a person skilled in the art and which actually satisfies virtually all the criteria of a random signal (autocorrelation etc.).

It is also known from information technology that a periodic time signal can be converted by means of a Fourier analysis to an image area, and an aperiodic signal can be converted by means of a Laplace transformation. The characteristics of the abovementioned transformations indicate to a person skilled in the art that, for example, a so-called Dirac impulse can be represented in the time domain only by a very broad frequency spectrum.⁸ Since frequencies and energies can be converted to one another, a Dirac impulse therefore requires a very broad energy spectrum. Orthogonality therefore exists between the variables time and energy as well, as is confirmed in particular by the Heisenberg uncertainty theorem. ⁸Woschni: Informationstechnik [Information technology], VEB Verlag Technik, Berlin, 1988

(System) time is proportional to the change in information within the system.

t˜Δ1 (2.2.)

However, since energy and time are orthogonal with respect to one another in accordance with E*t-t*E=h/2πi⁹, energy and information must also be orthogonal to one another. Such orthogonality is known, for example, in the case of sine and cosine. Small sine values mean high cosine values, and vice versa. This is precisely the same effect as that between energy and information as well, as is used according to the invention. ⁹According W. Heisenberg: “Über den anschaulichen Inhalt der quantentheoretischen Kinematik und Mechanik” [On the clear content of quantum theoretical kinematics and mechanics], 1927, in “Dokumente der Naturwissenschaft” [Documents on Science] Physics, Battenberg Verlag, Stuttgart, 1963, page 14 states: E*t-t*E=h/2πi. The variable i=√(−1) in this case expresses this orthogonality mathematically.

A quantum is described by its energy and information state. The energy value on the basis of E=h*f, results directly from its frequency. However, the information value of a quantum can also be derived. In contrast to sine and cosine, neither energy nor information of a quantum can become zero since the Heisenberg uncertainty theorem forbids this. The situation in this case is that, when a quantum has extremely high energies, very few information items occur (or are measurable), but a very large number of information items occur when the energies are extremely low. Particularly in the very low energy range described here, relatively large quantities of information can occur (or can be measured).¹⁰ ¹⁰One indicator of the correctness of this theory occurs in the case of so-called homeopathy, which has successes particularly at very high powers, that is to say with extremely major dilutions. In homeopathic preparations, the power 1000 virtually no longer allows any material substance component (energies) to be verified, although a verifiable effect can be achieved in the patient with these high powers.

This means that quanta in the very low energy range are pronounced to a very much greater extent by their information coded in them, because of the orthogonality of energy and information, than high-energy quanta. The so-called ur theory (quantum theory of the ur alternative by C. F. Weizsäcker) goes one step further, however, and explains the information as the actual, fundamental module in the world, and not the energy (Holger Lyre, Information Theory, UTB Verlag für Wissenschaft, Munich 2002). This appears to be plausible particularly in the field of very low-energy quanta.

As already explained, it is known from quantum mechanics that the product of the accuracy of the impulse Δp and location Δx must always be greater than or equal to Planck's constant h (equation (2.1)). Furthermore, this is not a consequence of inadequate measurement systems, rather an inherent natural phenomenon. Quantum mechanics explains the location, Ax by a probability function [symbol] . According to this theory, the “virtually point size” microparticles will have to arrive anywhere within the location Δx; all that is not known is where. The true location x1 can be determined only by the act of measurement, which is then referred to as the “collapse of the wavefunction” [symbol] ¹¹ and a more recent piece of data, see Tipler 2006.¹² However, the exact impulse p1 is once again blurred by the determination of the location x1, and vice versa. ¹¹W. Heisenberg: “Über den anschaulichen Inhalt der quantentheoretischen Kinematik und Mechanik” [On the clear content of quantum theoretical kinematics and mechanics], 1927, in “Dokumente der Naturwissenschaft” [Documents on Science] Physik, Battenberg Verlag, Stuttgart, 1963¹²Tipler, Mosca: Physik, Spektrum Akademischer Verlag, Munich, 2nd edition, 2006, page 1126

In contrast to the traditional explanation, a working model is assumed as the basis here in which the quantum is a really existing physical structure of extent Δx (and with Δy and Δz as further spatial dimensions). According to this model, the quantum is not so small as quantum mechanics predicts and, instead of this, it may have spatial extents in the order of magnitude of its wavelength. By way of example, this also explains the known double-slot experiment, in which it is possible to show that a quantum interferes with itself. This is because, even if the intensity of the radiation source is so low that the quanta arrive at a double slot successively separated in time, interference patterns occur beyond the double slot, although it has not yet been possible to explain these satisfactorily.¹³ It is assumed in the description that the quantum has a physical extent such that it also receives the information from the other slot when passing through one slot and, based on the two information items, interferes with itself. As a result of this self-interference, information relating to both slot locations is available beyond the slot. The distance between and the width of the two slots have a suitable ratio to the wavelength of the quantum in these experiments. ¹³Feynman; Vorlesungen über Physik [Lectures on physics], volume III in Quantenmechanik (Quantum mechanics), Oldenbourg Verlag, Munich, Vienna 1992
In the description, the word quantum means that area of the wave packet in which the majority (for example 90%) of its energy is located. Purely theoretically, quanta may have an infinitely large extent, but they are generally considered to be a Gaussian wave packet. In this case, it is assumed that a quantum does not have any inherent form, but that the energy distribution (form) which actually occurs always results from the interaction between the quantum and the (spatial and time) environment. A quantum in a potential pot has a different energy distribution (form) than a free quantum or a quantum in a rectangular slot.
In quantum mechanics, the wave packets of the quanta which can develop according to the Schrödinger equation are interpreted as probability waves. This viewpoint is not supported here since the wave packets—as shown above—can be interpreted as being physically real. Quanta have a spatial extent which depends on their wavelength. The “mathematical problems of the wave packets melting away as a function of time” which are linked to this viewpoint of the actually existing, spatially distributed wave packets can be solved theoretically.
The spatial viewpoint postulated here and the known traditional viewpoints are, however, equivalent for the technical application of the invention since the quantum interacts wherever it comes into contact with other quanta. Whether this leads to a collapse of the probability wave function (traditional viewpoint of quantum mechanics) or the quantum interacts precisely at this point at which contact is made with it is not of critical importance for the invention and its technical application.

The spatial viewpoint is therefore only a working model by means of which effects which can actually be measured can be explained. In the end, it is irrelevant whether the extent actually really exists or whether the quanta take energy from remote locations in different ways, as is the case in the double-slot experiment. The critical factor is that quanta interact with themselves on passing through a slot (slot 1) and, during this interference, process information from physically remote locations (slot 2). This is the only way in which the generally known interference patterns on a double slot are created. Quanta accordingly have at least information from all locations of their uncertainty range.

A further indication that quanta have a real physical extent also results from the uncertainty theorem itself, in addition to the double-slot experiment mentioned above. The energy of a quantum at 8 Hz is, according to E=h*f approximately E(8 Hz)=5.3*10⁻³³ J.

The accuracy of an energy measurement (or pulse measurement) must therefore at least be more accurate than 5.3*10⁻³³ J. This is because very low-energy quanta in fact actually require extremely high accuracy of the measurement of their impulse and their energy (or frequency), since, in the end, the measurement inaccuracy must be less than the energy of the quantum itself; in general, the measurement accuracy should be one order of magnitude more accurate than the values to be measured. Therefore, absolutely necessarily, very low-energy quanta have an extremely high uncertainty with regard to location. This is consistent with the assumption that very low-energy quanta are “blurred” over a very large location, that is to say they are located at the same time at the location Δx (and Δy and Δz).

In consequence, both quantum mechanics and experiments relating to the double slot support the postulated model assumption that quanta have a physical extent in the order of magnitude of their wavelength, but at least have information about their entire spatial uncertainty range.

According to the invention, this model assumption is now also extended to the time domain. Precisely in the same way as a quantum is “blurred” over the location Ax (and Δy and Δz), then it is always also “blurred” over time Δt. In addition, the amount of time is obtained from the simple conversion

Δt=1/Δf=h/ΔE (2.3.)

The known uncertainty of location and impulse also applies to the product of energy and time, which, as a result of the equivalence of time as an information change, means that both energy and information of a quantum can never be zero.

ΔE*Δt≧h (2.4.)

Equation (2.4.) is generally known from quantum mechanics¹⁴. For very low energies (2.4.) however, this has serious effects. This is because, precisely in the same way as a very low-energy quantum is distributed over the location (that is to say it is located everywhere at the location Δx), it is also “blurred” over time Δt. In principle, very low-energy quanta therefore have an uncertainty in time because it must be assumed that, when E is very small (ΔE→0) ΔE in particular must be very small (ΔE→0). According to equation (2.4.), the time uncertainty Δt for low energy quanta must therefore be very large, thus resulting in new time effects. ¹⁴W. Heisenberg: “Über den anschaulichen Inhalt der quantentheoretischen Kinematik und Mechanik” [On the clear content of quantum theoretical kinematics and mechanics], 1927, in “Dokumente der Naturwissenschaft” [Documents on Science] Physik, Battenberg Verlag, Stuttgart, 1963

According to the invention, this time uncertainty is used to project a certain time interval, for example, Δt/2, into the future. Other time intervals are also possible, but for simplicity reasons, the explanation will remain with this example.

By way of example, a brain quantum of 8 Hz results in a time uncertainty of Δt=125 ms, and therefore, for symmetry reasons, at the measurement time t0 in a “view into the future” of Δt/2=60.25 ms. By way of example, the human brain is therefore able to predict events of 60.25 ms and to identify the results of these events in advance. Effects which could confirm such a thing are well known from psychology and can be physically explained on the basis of the model assumptions made here. The extent to which the human brain can now perceive quanta with frequencies below 1 Hz (LSTEQ-quanta) for example 10⁻¹⁰ Hz, is unknown. However, it can be assumed that the brain is able to receive very low-frequency quanta, for example through specific trance states, in which 1) the conductor track length of neural paths connected is increased extremely, and/or 2) the noise level of other nerve activities is reduced such that the received very low-energy quanta can enter the consciousness. Numerous phenomena relating to a view of the future by so-called “medially gifted persons” can thus be explained physically. By a certain amount of training, these people learn to receive low-energy quanta and to process them. They can therefore receive information from areas located a long distance away, and about future events. It is evident from the model that the reception of information from a spatially long distance away should be easier than the reception of future information. This is because, even if the information of 8 Hz quanta in the brain (for example in the hypothalamus) can be evaluated, then, although information can be received from areas that are up to 37 500 km away, only future events of 60.25 ms can be received. The reception of future events several hours or years in advance therefore requires extremely low-frequency quanta. It is unknown whether the brain is able to receive these LSTEQ quanta. However, at the moment, it has not yet been possible to detect such frequencies and very low-energy quanta by hardware, that is to say by measurement.

Particularly when using semiconductor-based random number generators as receivers of very low-energy quanta, it is possible to develop such equipment allowing predictions into further, future areas other than, for example, just the abovementioned 60.25 ms. Using noise generators of suitable design, for example, quanta can be detected of such low energy that future events can be measured physically. If, for example, a random number generator is used to detect a quantum whose energy is 1.84*10⁻³⁷ J, then this corresponds to an uncertainty of Δt=1 h, which allows a view of the order of magnitude of about 30 minutes into the future. Events relating to an object can therefore be seen in advance at a time t0, which object transmits quanta at the time t0 to the receiver noise generator but which occur at the object only at the time t0+Δt/2.

Therefore, according to the invention, a method and device have been developed which, on the basis of the measurement of very low-energy quanta, make it possible to physically measure and evaluate future events at the current time t0.

The invention is therefore diametrically counter to present research in which attempts are being made with ever higher energy levels to “bend space and time”, in order to achieve novel phenomena in time measurement. These scientific considerations are described in physics by the popular scientific expression, so-called “wormhole”.¹⁵ According to the invention, novel time phenomena are, however, actually achieved with very low-energy quanta. ¹⁵F. Tipler. Die Physik der Unsterblichkeit [The physics of immortality], Doubleday, New York, Munich, 1994, page 520 et seq.

A specific description of the time self-interference of quanta is illustrated once again in FIG. 2 and FIG. 3:

The basis is once again the known double-slot experiment: a quantum (LEQ) which arrives at a double slot in the direction DIR interferes with itself there when the double slot is in the same order of magnitude as the wavelength, that is to say the quantum has the information of the other slot (through which it is not passed) (x2) when passing through one slot (for example x1).

When λ is very long, for 8 Hz quanta λ=37 500 km, the quantum at the point x1 has information relating to the point x2, that is to say from a point which is 37 500 km away. LEQ quanta therefore have information from a location x2 even when they are evaluated at a location x1 a long distance away.

Interference patterns occur even when the slot separation is less than Δ/4, for example Δ/8, Δ/16 or Δ/32, although the patterns in this case are always weaker, and beyond a certain point interference can no longer be verified. If the gap separation is greater than Δ, for example 10*Δ, there is no interference image on the screen SC. The quanta once again behave like normal particles.

These physical relationships of the double slot can be transferred analogously to the time domain (FIG. 3).

New effects result from the interchange of the location and time dimension according to the invention.

A quantum LEQ is sampled at a specific location at two times t1 and t2 which occur one after the other. The two sampling times in this case adopt the previous function of the double slot x1 and x2. The entire time sampling pattern, seen in simple terms, represents a three-dimensional grid. The interference pattern can be varied by choice of the sampling intervals. The slot width of the grid is produced, in the case of time, by sampling of not just a single value of the signal at a sampling time t1 but, for example sampling 10 to 100 values at a sampling rate that is 1000 times higher, from which, for example, the mean value is then selected. The sample value produced in this way at the time t1 also at the same time includes information from the time t2. There is a time effect between t1 and t2, which cannot be prevented. Sampling always links one quantum in time to itself, that is to say the specific sample value of a signal at a time t1 always also includes information relating to the sample taken at the future sampling time t2 of the signal (and also from the previous signal).

If t is now chosen to be sufficiently large, for the case of 0.01 Hz quanta, t=100 s, the quantum at the time t1 has information from a time t2 which is still 100 s away in time. LSTEQ quanta can therefore transmit information of an object from a time t2 to a time t1 (t2>t1). The current sample value always already contains information from the future sampling time of the signal, as well. Precisely in the same way that the location of the occurrence of the next quantum cannot be predicted in the case of the double slot, this future sample value cannot be derived from this, and still remains random. Interference characteristics can be determined only in the overall distribution (for example amplitude density).

Interference patterns in which the results of the time linking are stored also occur when the time interval is less than ¼f, for example ⅛f, 1/16f or 1/32f, but the patterns are in this case always weaker, and beyond a certain point, no interference and therefore also no information can be verified from the time t2. t2 is then simply a time which is too close to the point t1 in order to store still measureable verifications from t2. If the time interval is greater than 1/f, for example 10*1/f, there is also no interference pattern in the distributions. The quanta behave like normal particles, t2 is then too far away in time in order to still contain measureable verifications at the point t1.

Optimum sampling of the 0.01 Hz quanta (t=100 s) would therefore occur every 1/0.04 Hz=25 s (or 50 s). The two sample values t1 and t2=t1+25 s are linked to one another in time, that is to say the measured interference pattern is formed by the values from the noise generator themselves.

This is the only reason why no traditional interference pattern exists in the amplitude density distributions of sampled random signals, since the random signal comprises a broadband frequency mixture. The interference pattern of the amplitude density is therefore blurred in precisely the same way as that on the double slot would be blurred as well if a frequency mixture were to be applied to the slot rather than coherent waves. In contrast, if sampling were to be carried out using a pure frequency (sine-wave signal), this would result in an amplitude density which is increased to the left and right. A sampled signal which comprises one frequency with a narrow fluctuation width (that is to say which is virtually coherent) produces, with suitable adjustment, an amplitude density which reminds one of a traditional interference pattern. Quanta interfere with themselves in time.

According to the invention, the circumstance of time self-interference of quanta is used in order to obtain potential information about the future behavior of objects.

This is achieved most easily by relating two successive random values to one another (difference or quotient). Since the random value may already contain information from the time t2 at the time t1, it is possible by comparison with the later sample value relating to the time t2 to determine whether, for example, an appliance will become defective. What the ratio must be between two successive random numbers in the end in order to arrive at a semantic statement is determined in advance by a calibration process.

Important problems in the case of the measurement of potential information are therefore the solution a) of the addressing, of the object about which a statement is desired, that is to say the selection of the desired information from the permanent information mixture, and b) the interpretation of the changes to the random number generator.

Solutions to both problems a, b will be described in the following text:

### a) Addressing Or Selection

Addressing is carried out by transmitting addresses of the transmitter to the receiver. Addresses are, for example, a surrogate of the transmitter. Each transmitter transmits its information to the environment along an entropy gradient all the time. The problem at the receiver is to filter out this information. Since the low-energy quanta can be transmitted over a very long distance, all the possible quanta, that is to say even those from transmitters a very long distance away, are superimposed in the receiver. The receiver has to filter the quanta of the transmitter from these superimpositions.

There are a number of methods for selection. On the one hand, the method of calibration between the transmitter and receiver, see the following paragraph b), and on the other hand the identification of the transmitter on the basis of its individual transmitter features. Since the transmitter is not selected on the basis of determination of signal amplitudes, the distance between the transmitter and receiver is also of secondary importance.

Every material production process results in entanglement between the original (A) and the duplicate (A1), in the respect that the original and duplicate exchange information all the time, and the information exchange can be filtered out from the other influences from the environment. The original and duplicate have a potential resonance relationship.

Two alternative viewpoints are possible for the physically implemented entanglement, but both have the same technical application options.

i) The entanglement must not be understood in quantum-mechanical terms, since it is not true that what happens to the object A will also happen at the same instant to the object A1, in the sense of the known remote effect of entangled quantum states. The entanglement simply means fine tuning of the frequency such that the original and duplicate can exchange information.

ii) The entanglement must be understood to be quantum-mechanical, that is to say that which happens to the quanta of the object A also happens at the same instant to the quanta of the object A1, in the sense of the known remote effect of entangled quantum states. However, since no absolutely identical duplicate exists, then the effects of the changes in A can admittedly be received at that instant in A1 but, since A1 still also has different quanta than A, the state of A1 does not change identically to the state of A. Only the entangled quanta of A and A1 change their states identically.

Both i) and ii) can be technically made use of in the same manner by setting a receiver to the frequency of a transmitter.

There are therefore three options for addressing:

1.) The addressing of a transmitter A in the receiver B can be carried out by any type of surrogate A1, that is to say parts of the object of A itself, digital fingerprints, identical components (for example identical diodes in the transmitter and receiver), unique serial numbers etc. By way of example, the surrogates are inductively or capacitively coupled to the tuned circuit of the semiconductor component that is being used, by means of a specific device (plate capacitors, windings, measurement cups).

2.) Another option for addressing is the alignment of the receiver with the desired object with corresponding measurement probes, antenna installations or collimators.

3.) A further simple option for addressing is provided by the choice of the sampling frequency. Transmitter objects and receivers produce noise over a very broad spectrum. By the choice of its sampling rate, the receiver decides which quanta it wishes to receive, and with what energy. If, for example, the aim is to receive quanta whose energy is E=5.3*10⁻³³ J, that is to say 8 Hz quanta, because the brain frequencies of a human being are intended to be evaluated, a suitable sampling rate for the noise generator is 16 Hz. Higher-frequency noise components were produced significantly by other quanta. All of these information items are superimposed at the generator to form the typical, known noise signal of the noise generators. The crucial factor for the evaluation algorithm that is used is whether the “pure” 8 Hz values are used or whether the noise generator is nevertheless sampled at a higher rate, with only the 8 Hz mean values being included in the further processing.

### b) Interpretation Or Calibration

### b1) Motivation For Calibration

At the moment, there are various projects throughout the world in order to identify patterns from global or local noise data, and to interpret these patterns in order to make predictions or for correlation. The so-called Global Consciousness Project at Princeton University is known¹⁶, in which noise generators have been installed throughout the world for 20 years and attempts have been made in this time to correlate the results of the noise measurements with global events such as earthquakes, volcanic eruptions, and terrorist attacks. ¹⁶ noosphere.princeton.edu

One important aim in this case is to identify whether the statistical characteristics of the noise signals change before or after global events. The aim in this case is to form an indicator or prognosis for specific global events.

These projects have been successful to a greater or lesser extent. This is because of the fact that the statistical characteristic values relating to global events have a random behavior. The main reason is that incorrect characteristic values are being searched for. If the low-energy quanta are considered to be part of an alphabet of a communication language, which is still unknown, of technical and biological systems, it becomes clear that the analysis of the occurrence of mean values, median values, scatters, etc. cannot indicate any actual relationship with the events, of whatever type. All of the abovementioned projects which wish to make predictions about events from statistical patterns in the time sequences of noise data will therefore fail if the predictions are intended to include a certain level of complexity and non-triviality.

One particular problem in the analysis of noise data is also that the influence on the noise processes being examined by quanta from other objects and processes (also at a long distance) could in principle all be filtered out of the noise data. The only important factor in this case is to select the respectively correct filters, then complex patterns or else simple repetitions can be found in the noise data. However, it must also be remembered here that the patterns found will sometimes themselves only be artifacts of the method, that is to say patterns which are produced only by the analysis method. Every examination must therefore be limited in time, although this means that multiplication of the noise signal by a time window and mathematical convolution of the examined random function with a square-wave function in the image area of its Fourier transforms, which in turn results in periodicities that are method-dependent. Particularly if the examinations analyze trivial relationships, that is to say correlation, histogram similarities, subordinate frequencies, fractal structures, mean-value discrepancies, drift etc., is it possible to find precisely what one was looking for in the noise data.

However, even if one excludes these method errors, the desired information can generally not be found by means of the abovementioned statistical evaluation processes since the correlations that are sought, for example between noise values from random number generators and global events, exist only in the trivial case. Nevertheless, global events in the noise sequences from random number generators can and will be indicated in advance, although they can only be found using the present-day methods of statistical and stochastic analysis of random processes.

Significant results can be achieved only by considering the noise data as an alphabet of noise values which are produced by quanta. However, according to the invention, this means a transition from the purely statistical and stochastic analysis of random processes to a semantic analysis of these sequences. This is because random sequences form letters, words and sentences of an information exchange which is physically created by quanta.

However, even if one does not know the alphabet of quantum information as postulated above (this is not known in particular in the case of natural systems), complex information can be transmitted in that both the transmitter and the receiver of the information can control a coding and decoding method, which is admittedly unknown but has nevertheless been agreed on, that is to say by both sides defining a semantic.

The possibility of a complex (and therefore semantic) information exchange between a transmitter and a receiver is provided by the calibration process. The calibration is thus particularly advantageous when signals from nature are intended to be received and interpreted, since it is in fact impossible to deliberately affect the quantum emission from the transmitter. In the case of a technical communication, in which the transmitter and receiver are noise generators for example, the transmission quanta can be specifically generated and the calibration procedure can thereby be carried out at least only in a simplified form.

### b2) Calibration

In order to significantly improve the results of reception using random number generators, the generators must be calibrated in this context when they are intended to receive relatively complex information items. In this case, the calibration defines the semantic level between the transmitter and receiver.

A simple calibration process, that is to say tuning between the transmitter and receiver by means of the information content of the messages to be exchanged, in the example of a “calibration by means of the level of the entropy” in the transmitter object can be technically integrated in the process, for example, as follows (FIG. 4):
Addressing of transmitter A in the receiver B by use of an identifier ID, e.g. use of a surrogate A1 of the transmitter
Defined increase in the entropy of the transmitter (for example by heating) and transmission of entropy quanta (LEQ or LSTEQ).
Reception of the entropy quanta at the receiving noise generator RNGB, whose behavior is influenced by the quanta but is still random or statistically appears to be random
Processing of the amplitude values of the noise generator by means of a specific algorithm PRZB, and generation of a number or numerical sequence
Interpretation of the numerical sequence as high or low entropy in the transmitter, and checking whether this corresponds to the facts in the transmitter.
Calibration:
   When the statement of the receiving noise generator RNGB is correct for the user (high entropy measured, when high entropy is present), the calibration process is continued using different entropy values of the transmitter.
   When the statement of the receiving noise generator RNGB is, however, incorrect for the user, then the parameters of the noise generator and of the evaluation algorithm must be adapted systematically with the same transmitter setting (for example changing the value range of the noise generator, the sampling rate of the noise generator, the coefficients of the algorithm, normalization), to be precise until the information emitted (and known) by the transmitter has been received correctly in the receiver.
   Following this, continuation using different settings.

After the calibration, the receiver will have been set to the low-energy quanta of the transmitter and can correctly interpret subsequent quanta, that is to say the transmitter sends information on whether it has high entropy, then the calibrated receiver receives this entropy correctly in that it “randomly selects” a numerical sequence, which is identified as having high entropy in the subsequent algorithm. The semantic is defined.

However, this means that different receivers which have also been calibrated differently for various reasons may react differently to the same information from one transmitter. However, this has been known for a long time from the automata theory. This means that since a complex receiver of quanta generally has an internal state and a specific algorithm for processing the quantum information, an identical message in the receiver (an identical quantum or a sequence of quanta) can lead to different “deflections” or interpretation. Calibration of a receiver is therefore required.

Transmitters and receivers can communicate with one another according to the method by implementation of the addressing and calibration.

After a receiver has received (selected) and can interpret the information of an object (transmitter) to be examined, the effect of the self interference of quanta can be utilized in order to obtain potential information from the examined object. Each sampled value at time t1 contains potential information of future value t2. By comparing both values, it is then possible to make a statement about the future development of the object.

From time to time, one reads in the literature of white noise being used as a carrier of a novel communication channel, which has not yet been discovered. However, the white noise is not the carrier of information modulated onto it, but the white noise is the information itself. This is because low-energy quanta have the physical characteristic of extending spatially and in time very widely and of expanding, for which reason a novel information technology need not modulate any information onto a carrier wave. The information of a transmitter object is transmitted by existing natural transmission mechanisms, a large spatial and time extent of quanta, and their major penetration to the receiver.

The novel data communication described here easily reads the information sent all the time by each object from the noise. According to the invention, nature carries out the actual data transmission itself, so to speak. The major content of the invention is therefore, based on novel receivers, to use random number generators to receive the low-energy quanta carrying information, and then selectively to filter them out.

Specific addressing and calibration are required for this purpose.

For example, this results in completely new capabilities for remote diagnosis of patients, remote monitoring of technical installations, therapy capabilities, communication with the very seriously disabled and prognosis capabilities.

Four technical applications of the invention will be mentioned by way of example in the following text.

1.) It is possible by means of the method according to the invention to objectively read information states of a biological system by constructing information sinks which enter resonance with specific desired information in the transmitter. In the same way that one can objectively diagnose mental states of people, since the states correspond to certain entropy relationships which can be received by receivers that are suitable for this purpose, other brain states of a person or of a biological system can also be detected by measurement. In contrast to conventional methods using EEG signal evaluation, which is incorrectly carried out in the high-energy area (in the view of the invention), low-energy quanta, which represent specific brain states of a person, can be received and evaluated by the reception of quanta by means of noise generators.

Applications relating to this are diagnosis systems, lie detectors, communication systems for the very severely disabled, and therapy appliances.

2.) By means of the method according to the invention, it is possible to objectively read information states of a technical system by constructing information sinks which resonate with certain information in the transmitter. This makes it possible to objectively diagnose defective states of appliances or installations since the states correspond to certain entropy relationships which can be received by receivers which are suitable for this purpose. In contrast to conventional diagnosis methods by means of signal evaluation, which are incorrectly carried out in the high-energy range (from the point of view of the invention), low-energy quanta which represent certain installation and appliance states can be received and evaluated by the reception of quanta by means of noise generators.

Applications relating to this are technical diagnosis systems for power stations, aircraft, cars and all technical appliances. In this case, the appliance and the receiver need not be electrically connected. Furthermore, the appliance and the diagnosis system may be spatially separated, thus implying numerous applications, for example remote diagnosis of cars, etc.

3.) LSTEQ quanta are used for prediction. Owing to the fundamental time uncertainty for reception of very low energy quanta, certain process states and therefore also events can be predicted. Depending on the quality of the noise generator, it is possible in this case to measure in detail events which will occur between several milliseconds and several hours (or more) in the future. The matching to the specific energy of the object to be measured (technical or biological system) is in this case carried out as explained in the above descriptions of addressing and calibration.

Applications relating to this are technical prognosis systems for private industry or other devices for users who require short-notice information about events that are about to occur. However, these applications are limited by the extremely low level of the energy to be measured (down to 10⁻³⁸J or less) and the extremely high qualities of the noise generators required for this purpose. If, for example, one wishes to receive information about states of objects or processes which they will not assume until about one hour later, receivers are required which can receive very low-energy quanta (LSTEQ quanta) with an energy of 9.20*10⁻³⁸J or less.

Although, in principle, all random generators are suitable for these applications, in addition to semiconductor-based noise generators from some investigations with a short time window, it is also possible, inter alia, to use noise generators based on radioactivity, for example measurement of the noise produced from the alpha decay of plutonium. One reason is that alpha decay generators can be influenced only with difficulty by environmental factors (room temperature, ambient humidity, electrosmog, etc.), as a result of which their decay rate fluctuations are caused by the desired low-energy quanta of the desired field type. However, in the case of alpha decay, care should be taken to ensure that the collimators are aligned exactly in space.

One vision of the application could, for example, also be of interest for astrophysics since the abovementioned generators could be used to aim at corresponding cosmic objects (for example by means of collimators) and to analyze them, when these objects are a long distance away and information as to how these objects are behaving at that particular moment can be obtained even from these objects which are a long distance away.

4.) It is known that there are certain groups of people who can use various instruments, such as pendulums or divining rods for example underground water flows or raw material resources, and to carry out other activities. These activities are nowadays not considered to be serious since they often cannot be checked or at least are not reproducible.

With the low-energy quanta receivers described here, all of these so-called radionic activities can be constructed and implemented reproducibly by technical appliances, and this will be explained using the example of a single-handed divining rod.

It is known that someone carrying a divining rod must calibrate this in advance since, in fact, it is actually not known what non-voluntary muscle deflections lead to the respective reactions of the divining rod in what question situations. After calibration, the divining rod can respond correctly to relevant question situations for the user, since the muscle movements are in fact produced involuntarily, and the divining rod only produces a response such as this with the intention of creating an involuntary action by a person which could not penetrate to the consciousness because of different nerve activity in the brain.

These tasks of specially trained personnel can be carried out technically by so-called “electronic pendulums” (ELPs).

By way of example, an ELP operates as follows: a thermal noise generator, for example a zener diode, is used as a noise source, as the specific receiver of low-energy quanta. This analog noise source is then sampled, for example at a frequency of 15 Hz, and is digitized. The binary random number sequence that is produced is then evaluated in a PC for a predetermined time interval, for example of 5 seconds.

An ELP must be calibrated on the basis of its technical implementation. In this case, a first question is chosen from a set of about 100 questions (whose correct responses are all known), and this first question is then preset for the ELP. The check of the ELP is then started, and the response is awaited. During the check, the number of zeroes and ones—which the noise source has produced—is counted and evaluated over a time interval. If, for example, more ones were to occur than zeroes, then this can be interpreted as “yes”, and vice versa. If one agrees with the response, the next question is then selected, and the calibration procedure is repeated. If the response is not correct, the algorithm is adapted (for example changing the value range, changing the processing algorithm for noise data). The calibration of the ELP is carried out until the ELP has responded to about 85% of the questions in the manner expected by the user. The ELP can then be operated in the user mode and responds correctly to newly asked questions on a more than statistically expected level. After the calibration, the user can also ask the ELP system questions about potentially future states. Since, according to the invention, the current sample values from the noise source still also always contain information elements from future sample values, first information items can therefore be obtained about future characteristics of the object being examined.

The correctness of the responses is higher than the statistical expected value because the “operator and ELP” system has learnt to give correct responses during the calibration. The learning process is carried out in such a way that the low-energy quanta emitted by the human being influence the random number generator of the ELP, in the example the thermal noise generator, in such a way that the exact random value which represents the correct response is actually produced. The calibration is therefore necessary because 1) every person emits quanta of somewhat different energy (and) information and 2) the “operator and ELP” system must also be set to the specifically implemented algorithm for evaluation of the numbers.

All random number generators of suitable design can be used as a noise source for ELPs. However, in practice, the body noise of the operator himself, for example, can also be used as a noise source. So-called otoacoustic noise signals (that is to say noise generators which can measure and process the noise in the inner ear) or systems for measurement of fluctuations in the skin conductivity as a noise source, can be used for this purpose. The ELP can also be worn as a type of clock with a metallic base directly on the skin on the arm, and can be used in a mobile form. Further mobile options would be implementations in a mobile telephone, in an organizer etc. Providing that it has previously been correctly calibrated, the ELP can therefore, so to speak, provide the answers which the subconsciousness of the person would have wished to give to the question asked.

ELP systems can also be used for other purposes such as knowledge generators, lie detectors or for medical therapy in order to provide a reminder of things which have left the consciousness.

### FIGURE DESCRIPTIONS

FIG. 1

ENV Environment

LEQ Low-Energy Quanta

RNG Random Number Generator

PRZ Processor

DEVICE Device

s Distance

FIG. 2

LEQ Low-Energy Quanta

DIR Direction

SC Screen

FIG. 3

LEQ Low-Energy Quanta

TIME Time

SC Screen

FIG. 4

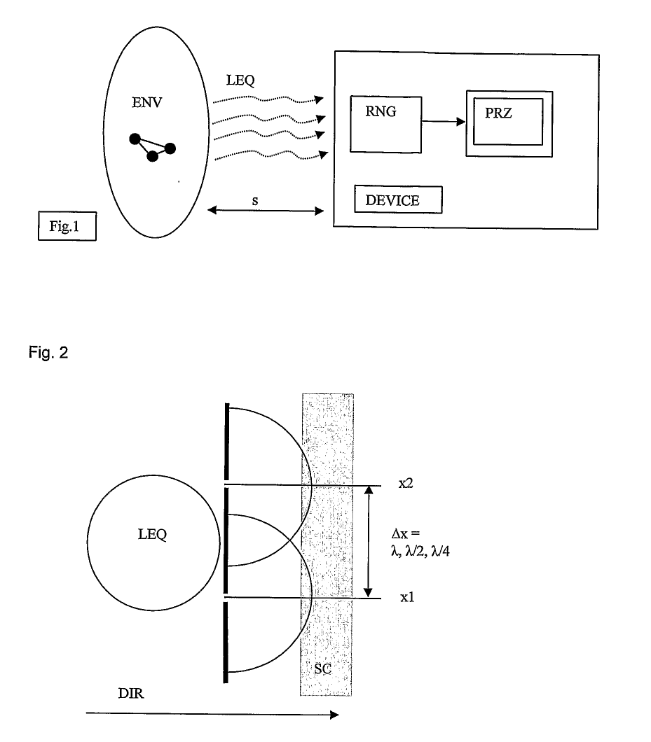

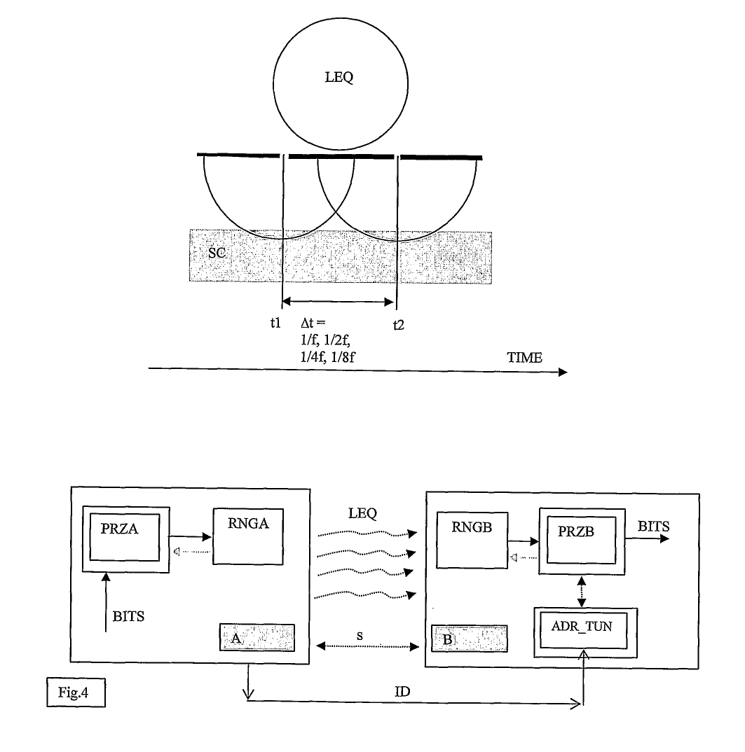

PRZA Processor A

BITS Bits

RNGA Random Number Generator A

LEQ Low-Energy Quanta

s Distance

PRZB Processor B

BITS Bits

RNGB Random Number Generator B

ADR_TUN Address Tuning

ID Identification

1-17. (canceled)

18. A method for measuring information of technical and/or biological systems, said method comprising steps of
providing suitable receivers formed as noise generators for receiving and evaluating low-energy quanta LEQ with a frequency in the range between 1 Hz and 100 Hz or very low-energy quanta LSTEQ with a frequency of less than 1 Hz,
receiving said low-energy quanta or very low-energy quanta by said receivers,
evaluating said received low-energy quanta or very low-energy quanta with the physical relationship between frequency and energy being used in order to determine the energy of the low-energy quanta or very low-energy quanta to be received and in order to use the noise generators as receivers or transmitters of low-energy quanta or very low-energy quanta,
time sampling the noise signal generated when receiving low energy quanta or very low energy quanta,
selectively filtering out the received low energy quanta or very low energy quanta from the noise signal.

19. The method as claimed in claim 18, wherein the received quanta originate from human beings.

20. The method as claimed in claim 18, wherein the received quanta originate from natural systems such as animals, plants, minerals or other materials.

21. The method as claimed in claim 19, wherein the receivers, which are based on noise generators, of low-energy quanta are used for diagnosis of illnesses, or for diagnosis of mental states.

22. The method as claimed in claim 19, wherein the receivers, which are based on noise generators, of low-energy quanta are used for communication with the very seriously ill.

23. The method as claimed in claim 19, wherein the receivers, which are based on noise generators, of low-energy quanta are used to determine the truth of human statements.

24. The method as claimed in claim 18, wherein the received quanta originate from technical systems such as automobiles, power plants, aircraft, or railroads.

25. The method as claimed in claim 18, wherein the received quanta originate from systems which are physically a long distance away, thus making it possible to carry out remote diagnoses of biological systems or remote monitoring of technical systems and installations.

26. The method as claimed in claim 18, wherein the reception or the emission of quanta can be screened deliberately by using suitable entropy sinks.

27. The method as claimed in claim 18, wherein the receivers, which are based on noise generators, of low-energy quanta are used for exploration of natural resources.

28. The method as claimed in claim 18, wherein the receivers, which are based on noise generators, of low-energy quanta are used for determination of materials, and these materials can thus be located specifically by calibration of the receivers for the corresponding materials, which makes it possible to select those quanta which those materials permanently emit, from the range of signals.

29. The method as claimed in claim 18, wherein the receivers, which are based on noise generators, of low-energy quanta are used for data communication, in that addressing and calibration are carried out between the transmitters and receivers of quanta, as a result of which the receiver can filter out the quanta sent via the transmitter from the information mixture of its noise generator, and can thus transmit a bit sequence from the transmitter to the receiver.

30. The method as claimed in claim 18, wherein a calibration process is carried out with the following steps:
addressing of transmitter in the receiver by use of an identifier, surrogate of the transmitter
defined increase in the entropy of the transmitter and transmission of entropy quanta
reception of the entropy quanta at the receiving noise generator, whose behavior is influenced by the quanta but is furthermore random or statistically appears to be random
processing of the amplitude values of the noise generator by means of a specific algorithm, and generation of a number or numerical sequence
interpretation of the numerical sequence as high or low entropy in the transmitter, and checking whether this corresponds to the facts in the transmitter calibration.

31. The method as claimed in claim 30, wherein the calibration comprises the following steps:
when the statement of the receiving noise generator is correct for the user, the calibration process is continued using different entropy values of the transmitter
when the statement of the receiving noise generator is incorrect for the user, the parameters of the noise generator and of the evaluation algorithm are adapted systematically with the same transmitter setting until the information emitted and known by the transmitter is received correctly in the receiver
following this, continuation using different transmitter settings.

32. The method as claimed in claim 18, wherein the low-energy quanta receivers based on noise generators are used for prediction, in that the known uncertainty theorem of quantum mechanics is used in such a way that a time uncertainty occurs in the measurement of low-energy quanta which, with suitable configuration of the receivers, therefore makes it possible to make statements about states of an object or a system which will occur therein only in the future.

33. The method as claimed in claim 18, wherein the receivers, which are based on noise generators, of low-energy quanta are used for setting up and for application of computer-aided divining systems (ELPs), in that a suitable calibration process matches an ELP and its user to one another, as a result of which the ELP will respond correctly more than statistically expected when subsequently checked.
